(19) United States
(12) Patent Application Publication
(10) Pub. No.: US 2011/0128273 A1
(43) Pub. Date: Jun. 2, 2011

(54) DISPLAY PANEL DRIVING CIRCUIT AND DRIVING METHOD USING THE SAME

(75) Inventors: Hyun-Min SONG, Cheongju-si (KR); Ji-Hun Kim, Daejeon-si (KR); Young-Bok Kim, Busan-si (KR); Joon-Ho Na, Daejeon-si (KR)

(73) Assignee: SILICON WORKS CO., LTD, Daejeon-si (KR)

(21) Appl. No.: 12/951,745

(22) Filed: Nov. 22, 2010

(30) Foreign Application Priority Data
Nov. 30, 2009 (KR) 10-2009-0117029

(51) Int. Cl. G09G 5/00

(52) U.S. Cl. 345/211

(57) ABSTRACT

A display panel driving circuit includes: N number of buffers (N is an integer no less than 1) configured to buffer data voltages and enable or disable supply of buffered signals in response to a charge sharing control signal; and N number of output multiplexers each configured to receive outputs of two adjacent buffers among outputs of the N number of buffers and transfer the output of one buffer or the outputs of the two buffers to a corresponding one of data lines in response to the charge sharing control signal.

### BACKGROUND OF THE INVENTION

1. Field of the Invention

The present invention relates to a display panel driving circuit and a driving method using the same, and more particularly, to a display panel driving circuit which can realize reduction in a power consumption and an area without using a separate switching block for a charge sharing operation, and a driving method using the same.

2. Description of the Related Art

A liquid crystal display is gaining popularity in the field of a computer monitor or a TV due to lightweight, flatness and low emissivity, when compared to a CRT monitor. Various researches have been actively conducted not only to improve qualities of a liquid crystal display such as color, contrast and brightness but also to reduce costs, a manufacturing time and a chip area to thereby increase the number of chips per wafer.

A liquid crystal display circuit displays an image by controlling an optical transmittance using an electric field. To this end, the liquid crystal display circuit includes a liquid crystal panel in which liquid crystal cells are arranged in the form of a matrix and a driving circuit for driving the liquid crystal panel.

The liquid crystal display panel driving circuit mainly uses a buffer and includes a separate function block for sharing charges of data lines. When the charge sharing block is simply realized, the respective data lines can be connected by switches. In this regard, even though each of the data lines has one switch, a considerably large portion of an entire area is occupied.

Due to the fact that charge sharing is enabled by the charge sharing block, advantages are provided in that positive data voltages and negative data voltages can be precharged to decrease power consumption of the liquid crystal display panel driving circuit. However, because the considerably large portion of the entire area is occupied, an adverse influence is exerted on the trend toward reduction in a chip area. Thus, measures for reducing the area of the display panel driving circuit is demanded for the sake of reducing a chip area.

### SUMMARY OF THE INVENTION

Accordingly, the present invention has been made in an effort to solve the problems occurring in the related art, and an object of the present invention is to provide a display panel driving circuit which can share charges without using a separate charge sharing block, thereby realizing reduction in a power consumption and an area, and a driving method using the same.

In order to achieve the above object, according to one aspect of the present invention, there is provided a display panel driving circuit including: N number of buffers (N is an integer no less than 1) configured to buffer data voltages and enable or disable supply of buffered signals in response to a charge sharing control signal; and N number of output multiplexers each configured to receive outputs of two adjacent buffers among outputs of the N number of buffers and transfer the output of one buffer or the outputs of the two buffers to a corresponding one of data lines in response to the charge sharing control signal.

In order to achieve the above object, according to another aspect of the present invention, there is provided a display circuit driving method including: a buffering step of buffering N number of data voltages; a charge sharing step of connecting signals of two adjacent signals among N number of buffered signals to corresponding data lines as a charge sharing control signal is enabled; and a data transfer step of disconnecting the data lines, connecting only signals corresponding to each polarity to the data lines, and intercepting remaining signals, as the charge sharing control signal is disabled.

### BRIEF DESCRIPTION OF THE DRAWINGS

The above objects, and other features and advantages of the present invention will become more apparent after a reading of the following detailed description taken in conjunction with the drawings, in which:

FIG. 1 is a diagram illustrating a display panel driving circuit in accordance with an embodiment of the present invention; and

FIG. 2 is a diagram illustrating operation timings of display panel driving circuits according to the conventional art and the present invention.

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

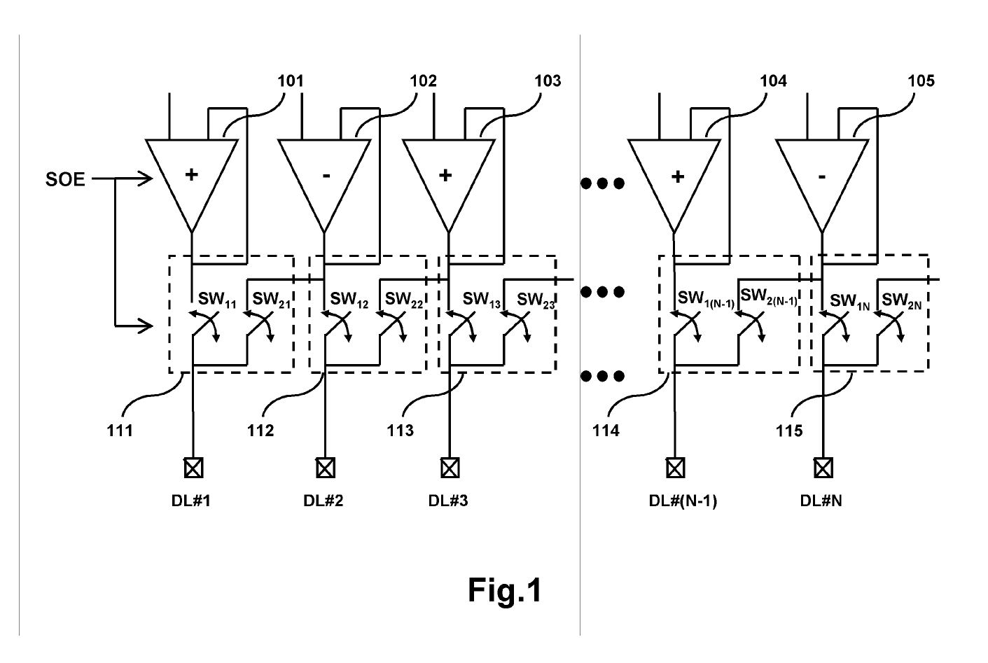

FIG. 1 is a diagram illustrating a display panel driving circuit in accordance with an embodiment of the present invention.

The display panel driving circuit shown in FIG. 1 includes N number of buffers 101 through 105 and N number of output multiplexers 111 through 115 (where N is an integer no less than 1).

The N number of buffers 101 through 105 are configured to buffer data voltages and enable or disable the supply of buffered signals to the N number of output multiplexers 111 through 115 in response to a charge sharing control signal SOE.

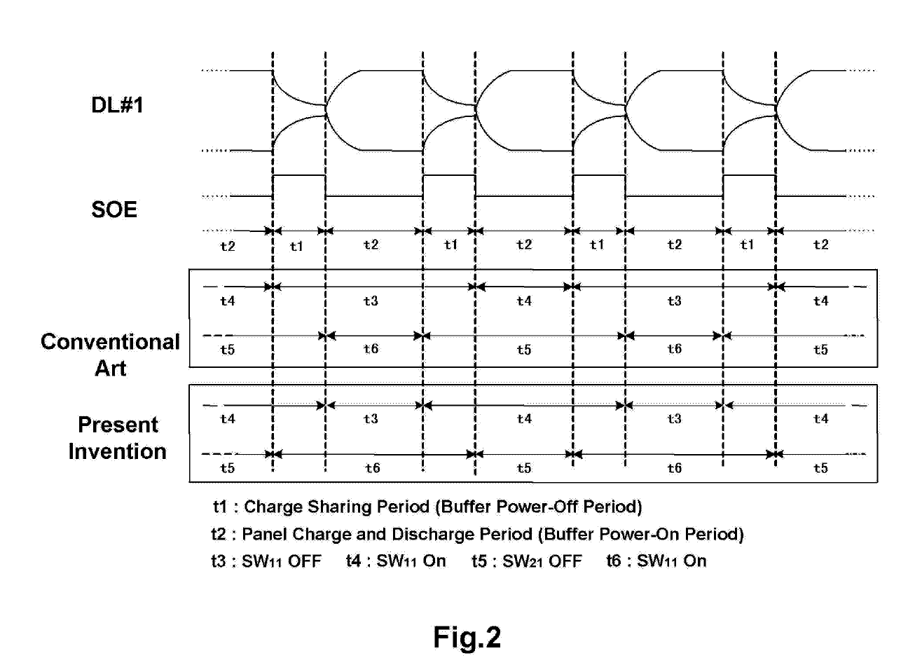

In the embodiment of the present invention, the charge sharing control signal SOE is a logic signal which determines whether or not to supply outputs of the buffers 101 through 105 to the output multiplexers 111 through 115 and distinguishes a charge sharing period t1 and a data transfer period t2 for transferring data to a liquid crystal display panel, as shown in FIG. 2. For example, in FIG. 2, if the charge sharing control signal SOE has a logic high level, a charge sharing operation is performed (for the charge sharing period t1) and the outputs of the buffers 101 through 105 are not supplied to the output multiplexers 111 through 115, and if the charge sharing control signal SOE has a logic low level, data is transferred to the liquid crystal display panel (for the data transfer period t2) and the outputs of the buffers 101 through 105 are supplied to the output multiplexers 111 through 115.

The N number of buffers 101 through 105 are constituted by positive buffers 101, 103 and 104 and negative buffers 102 and 105.

The positive buffers 101, 103 and 104 are buffers for driving a positive voltage of the liquid crystal display panel, and receive a supply voltage and a ground voltage as power sources and output the positive voltage.

The negative buffers 102 and 105 are buffers for driving a negative voltage of the liquid crystal display panel, and receive the supply voltage and the ground voltage as power sources and output the negative voltage.

As shown in FIG. 1, the N number of buffers 101 through 105 are disposed in such a manner that the positive buffers 101, 103 and 104 and the negative buffers 102 and 105 are alternately arranged.

In the buffers 101 through 105, the entirety of the buffers 101 through 105 may be powered off or only output terminals of the buffers 101 through 105 may be powered off, in response to the charge sharing control signal SOE.

That is to say, in the charge sharing period t1, as the charge sharing control signal SOE becomes high, the entirety of the buffers 101 through 105 are powered off or only the output terminals of the buffers 101 through 105 are powered off, so that no signals are outputted from the buffers 101 through 105.

Accordingly, data lines DL#1 through DL#N are not influenced by the buffers 101 through 105 during the charge sharing period t1.

Each of the N number of output multiplexers 111 through 115 is configured to receive the outputs of two adjacent buffers among the outputs of the N number of buffers 101 through 105 and transfer the output of one buffer or the outputs of the two buffers to a corresponding one of the data lines DL#1 through DL#N in response to the charge sharing control signal SOE.

In detail, the N number of output multiplexers 111 through 115 include N number of first switches SW₁₁, SW₁₂, SW₁₃, SW_{1(N-1)} and SW_{1N} and N number of second switches SW₂₁, SW₂₂, SW₂₃, SW_{2(N-1)} and SW_{2N} which are connected between the N number of buffers 101 through 105 and the N number of data lines DL#1 through DL#N.

The N number of first switches SW₁₁, SW₁₂, SW₁₃, SW_{1(N-1)} and SW_{1N} are configured to respectively switch the outputs of the N number of buffers 101 through 105.

The N number of second switches SW₂₁, SW₂₂, SW₂₃, SW_{2(N-1)} and SW_{2N} are configured to switch the outputs of the buffers which are adjacent to the buffers to which the N number of first switches SW₁₁, SW₁₂, SW₁₃, SW_{1(N-1)} and SW_{1N} are connected. One ends of the first switches SW₁₁, SW₁₂, SW₁₃, SW_{1(N-1)} and SW_{1N} and one ends of the second switches SW₂₁, SW₂₂, SW₂₃, SW_{2(N-1)} and SW_{2N} are commonly connected to corresponding data lines DL#1 through DL#N.

The first switches SW₁₁, SW₁₂, SW₁₃, SW_{1(N-1)} and SW_{1N} and the second switches SW₂₁, SW₂₂, SW₂₃, SW_{2(N-1)} and SW₂N are controlled by the charge sharing control signal SOE so as to be switched. For example, if the charge sharing control signal SOE has the logic high level, the first switches SW₁₁, SW₁₂, SW₁₃, SW_{1(N-1)} and SW_{1N} and the second switches SW₂₁, SW₂₂, SW₂₃, SW_{2(N-1)} and SW_{2N} are all turned on. If the charge sharing control signal SOE has the logic low level, the first switches are turned on and the second switches are turned off or the first switches are turned off and the second switches are turned on, according to selection of a polarity in the liquid crystal display panel.

The first switches SW₁₁, SW₁₂, SW₁₃, SW_{1(N-1)} and SW_{1N} and the second switches SW₂₁, SW₂₂, SW₂₃, SW_{2(N-1)} and SW₂N are complementarily connected with each other not in the charge sharing period t1 but in the data transfer period t2 and transfer the outputs of the corresponding buffers to the data lines DL#1 through DL#N or the outputs of the adjacent buffers to the data lines DL#1 through DL#N. Due to the fact that the first and second switches are complementarily connected with each other in this way, the outputs of the buffers 101 through 105 may be separated from one another.

For example, in the data transfer period t2, if the first switch SW₁₁ is turned on and the second switch SW₂₁ is turned off, the first data line DL#1 supplies a positive voltage to the display panel.

In the charge sharing period t1, all the first switches SW₁₁, SW₁₂, SW₁₃, SW_{1(N-1)} and SW_{1N} and the second switches SW₂₁, SW₂₂, SW₂₃, SW_{2(N-1)} and SW_{2N} are connected with each other and couple the outputs of the buffers 101 through 105 with one another, thereby sharing charges. By this fact, the data lines DL#1 through DL#N are precharged to a voltage of a middle level between a positive voltage and a negative voltage. In this way, as the data lines DL#1 through DL#N share charges through precharging, a voltage is averaged to the voltage of the middle level, and thereby, power consumption is reduced.

For example, if the first switch SW₁₁ and the second switch SW₂₁ are turned on in the charge sharing period t1, the charges of the first data line DL#1 and the second data line DL#2 are shared, and the first data line DL#1 and the second data line DL#2 are precharged to the middle voltage level between the voltages of both data lines.

While not shown in a drawing, the data lines DL#1 through DL#N are connected to capacitors in the display panel through serial and parallel connections of resistors and capacitors.

FIG. 2 is a diagram illustrating operation timings of display panel driving circuits according to the conventional art and the present invention.

In the operation of the liquid display driving circuit, the charge sharing period t1 and the data transfer period t2 (a panel data charge or discharge period) are repeated.

In the charge sharing period t1, the data lines DL#1 through DL#N share charges and are precharged to the middle voltage level.

In the data transfer period t2, the data lines DL#1 through DL#N are separated from one another, and data voltages as positive voltages or negative voltages are inputted to the display panel such that the capacitors of the pixels in the display panel are charged or discharged.

In the charge sharing period t1, both of the first switches SW₁₁, SW₁₂, SW₁₃, SW_{1(N-1)} and SW_{1N} and the second switches SW₂₁, SW₂₂, SW₂₃, SW_{2(N-1)} and SW₂N are turned on to connect all the data lines DL#1 through DL#N. Accordingly, the data lines DL#1 through DL#N are precharged to the voltage of the middle level.

FIG. 2 shows the voltage level of only the first data line DL#1 among the data lines. Observing the voltage of the first data line DL#1, it is to be appreciated that an abrupt curve is formed in the charge sharing period t1 rather than the data transfer period t2 and the data line DL#1 is precharged to the middle voltage level.

In the data transfer period t2, only the first switch SW₁₁ is turned on and the second switch SW₂₁ is turned off, or the first switch SW₁₁ is turned off and the second switch SW₂₁ is turned on.

In the data transfer period t2, it is to be appreciated that the voltage of the first data line DL#1 becomes a positive voltage during a period t4 in which the first switch SW₁₁ is turned on and becomes a negative voltage during a period t6 in which the second switch SW₂₁ is turned on. If the first data line DL#1 becomes the positive voltage, a capacitor in the display panel is charged, and if the first data line DL#1 becomes the negative voltage, the capacitor in the display panel is discharged.

Accordingly, the period t4 in which the first switch SW₁₁ is turned on and the period t6 in which the second switch SW₂₁ is turned on are lengthened when compared to the timing diagram according to the conventional art, and a period t3 in which the first switch SW₁₁ is turned off and a period t5 in which the second switch SW₂₁ is turned off are shortened when compared to the timing diagram according to the conventional art. In the charge sharing period t1, the output terminals of the buffers are powered off, and a charge sharing function and a data transfer function can be realized through one output multiplexer.

As described above, in the display panel driving circuit according to the present invention, as one output multiplexer performs both of a data transfer function and a charge sharing function, the charge sharing function can be performed even without using a separate charge sharing block which is otherwise provided in the conventional display driving circuit. As a consequence, since the area of the display driving circuit is significantly reduced, the number of chips per wafer can be increased. In particular, as the number of channels for supplying data increases, a charge sharing block can be further reduced in an area thereof, whereby effectiveness can be further improved.

As is apparent from the above description, the display panel driving circuit and the driving method using the same according to the present invention provide advantages in that a charge sharing operation is enabled even without using a separate charge sharing block, thereby realizing significant reduction in an area.

Although a preferred embodiment of the present invention has been described for illustrative purposes, those skilled in the art will appreciate that various modifications, additions and substitutions are possible, without departing from the scope and the spirit of the invention as disclosed in the accompanying claims.

What is claimed is:

1. A display panel driving circuit comprising:
N number of buffers (N is an integer no less than 1) configured to buffer data voltages and enable or disable supply of buffered signals in response to a charge sharing control signal; and
N number of output multiplexers each configured to receive outputs of two adjacent buffers among outputs of the N number of buffers and transfer the output of one buffer or the outputs of the two buffers to a corresponding one of data lines in response to the charge sharing control signal.

2. The display panel driving circuit according to claim 1,
wherein the N number of output multiplexers comprise:
N number of first switches configured to respectively switch the outputs of the N number of buffers; and
N number of second switches configured to respectively switch the outputs of the buffers which are adjacent to the buffers to which the N number of first switches are connected, and
wherein one ends of the first switches and one ends of the second switches are commonly connected to corresponding data lines.

3. The display panel driving circuit according to claim 2, wherein the first switches and the second switches are controlled by the charge sharing control signal so as to be switched.

4. The display panel driving circuit according to claim 3,
wherein, when the charge sharing control signal has a logic high level, the first switches and the second switches are turned on, and
wherein, when the charge sharing control signal has a logic low level, the first switches are turned on and the second switches are turned off or the first switches are turned off and the second switches are turned on, according to selection of a polarity in a display panel.

5. The display panel driving circuit according to claim 1, wherein entirety of the buffers are powered off or only output terminals of the buffers are powered off, in response to the charge sharing control signal.

6. The display panel driving circuit according to claim 1, wherein, in the N number of buffers, positive buffers for driving a positive voltage and negative buffers for driving a negative voltage are alternately disposed.

7. A display circuit driving method comprising:
a buffering step of buffering N number of data voltages;
a charge sharing step of connecting signals of two adjacent signals among N number of buffered signals to corresponding data lines as a charge sharing control signal is enabled; and
a data transfer step of disconnecting the data lines, connecting only signals corresponding to each polarity to the data lines, and intercepting remaining signals, as the charge sharing control signal is disabled.

8. The method according to claim 7, wherein, as the charge sharing control signal is enabled, the N number of buffered signals are disconnected from the data lines.

9. The method according to claim 7,
wherein, when the charge sharing control signal has a logic high level, first switches for switching the N number of buffered signals to corresponding data lines and second switches for switching signals adjacent to the N number of buffered signals to the data lines are turned on, and
wherein, when the charge sharing control signal has a logic low level, the first switches are turned on and the second switches are turned off, or the first switches are turned off and the second switches are turned on.
